(19) United States
(12) Patent Application Publication
(10) Pub. No.: US 2010/0155639 A1
(43) Pub. Date: Jun. 24, 2010

(54) SWITCHING UNIT FOR PUSHBUTTON OF KITCHEN WATER FAUCET

(76) Inventor: Huasong Zhou, Fujian (CN)

Correspondence Address: Dr. BANGER SHIA;Patent Office of Bang Shia, 102 Lindencrest Ct., Sugar Land, TX, 77479-5201, US

(21) Appl. No.: 12/600,477

(22) PCT Filed: Jul. 9, 2007
(86) PCT No.: PCT/CN2007/002100

§ 371 Date: Nov. 17, 2009

(51) Int. Cl. F16K 31/44

(52) U.S. Cl. 251/213

(57) ABSTRACT

A switching unit for pushbutton of kitchen water faucet cooperates with a water faucet body (1), a mandrel (2), a pushbutton mechanism (3), a bubbler (5) and a face covering (6). Two intake pipes (21,22) formed vertically in the middle of the mandrel (2) are communicated with the water inlet of the bubbler (5) and the shower water inlet of the face covering (6) respectively. The pushbutton mechanism (3) is arranged in the sidewall of water faucet body (1) and includes two buttons (32,33) capable of returning to initial state which aim at the two intake pipes (21,22). The valve core assembly (4) includes two valves (41,42), a pressure plate (43), and a return spring (44). The two valves (41,42) extend into the two intake pipes (21,22) of the mandrel (2) respectively, and the return spring (44) is arranged below the valve (41) in the bubble water intake pipe (21). The middle of the pressure plate (43) is connected pivotally with the upside of the partition between the two intake pipes (21,22), and the two ends of the pressure plate (43) are connected pivotally with the upside of the two valves (41,42) respectively. The pushbutton mechanism (3) and the valve core assembly (4) are arranged dividually and realize the switchover of shower water and bubble water using the seesaw principle. The return spring (44) makes the water faucet always keeping the bubble water state before water is turned on.

### BACKGROUND OF THE INVENTION

1. Field of the Invention

The present invention relates to a kitchen water faucet, in particular to a switching unit for pushbutton of kitchen water faucet.

2. Description of the Related Art

In typical technique, two kinds of kitchen faucets are generally performed. For example, one is adopted by a stationary type applying to fix the kitchen faucet with the water tank and preferably pivot the faucet on a fixed point thereon for its rotation, resulting in an inconvenience of using; the other one is adopted by a drawing type respectively disposing a soft pipe and a hard pipe at the interior and exterior of the outlet pipe of the drawing faucet, by which faucet could engage with a faucet body through the interior soft pipe. In use, the faucet could be detached from the hard pipe along with the drawing of the soft pipe so as to give an adjustable flush of water via grasping the faucet. Such faucet usually flushes water by two methods, for instance of bubbling and spraying water. The bubble water into a pipe is intensively carried for causing a small spatial flushing, which is in contrast to the sprayed shower water beneficial of scattering water for causing a larger spatial flushing. To prevent from splashing water of the kitchen faucet in a clutter while initially turning on the water, for those skilled in the art have been requested to bubble the water at the first time of using, which would inevitably require a safety switching device for cooperating therewith.

### SUMMARY OF THE INVENTION

The object of the present invention is to provide a switching unit for pushbutton of kitchen water faucet, which particularly designs an obvious switchover of the pushbutton and facilitates a restoration of the water flushing, so as to efficiently solving the ineffective lower pressure.

The configuration in accordance with the present invention designs a switching unit for pushbutton of kitchen water faucet cooperating with a water faucet body, a mandrel, a pushbutton mechanism, a bubbler and a face covering. Wherein, two intake pipes formed vertically in the middle of the mandrel are communicated with a water inlet of the bubbler and a shower water inlet of the face covering, respectively. The pushbutton mechanism is arranged in the sidewall of the water faucet body, which includes two buttons for returning to an initial state aiming at the two intake pipes, respectively. A valve core assembly includes two valves, a pressure plate, and a return spring. The two valves respectively extend into the two intake pipes of the mandrel; the return spring is arranged below the valve in the intake pipe of bubble water. The middle of the pressure plate is pivoted to an upside of a partition located between the two intake pipes, and two ends of the pressure plate provided with two ends thereof pivotally connect with upsides of the two valves, respectively.

Preferably, the pushbutton mechanism includes a pushbutton sleeve, whereby the two buttons connect with button springs and actively locate between the pushbutton sleeve and a sidewall of the mandrel.

Preferably, the two valves sleeved by a sealing unit respectively extend to the two intakes pipes of the mandrel, and lower portions of which are formed into a converse trapezoid contour for fitting with necks of the intake pipes.

Accordingly, the present invention takes advantage of the separate pushbutton mechanism and the valve core assembly and concurrently applies the pressure plate of the valve core assembly meeting a seesaw principle to attain an efficient switchover of the shower water and bubble water. Further, the configuration of the springs thence assists the switching unit in incessantly placing the bubble water intake pipe to an opening state before turning the water on and also placing the shower water intake pipe to a closing state. Therefore, such arrangement permits outputting the bubble water at the first using to avoid a flurry of water splashing and applies the cooperation of the two buttons and valves to render an obvious switchover of pushbutton for efficiently solving the ineffective lower pressure.

### BRIEF DESCRIPTION OF THE DRAWINGS

FIG. 1 is a cross-sectional view showing the structure of the present invention;

FIG. 2 is a schematic view showing of the present invention that outputs shower water;

FIG. 3 is a schematic view showing of the present invention that outputs bubble water; and

FIG. 4 is a schematic view showing of the present invention in a free state.

### DETAILED DESCRIPTION OF THE PREFERRED EMBODIMENTS

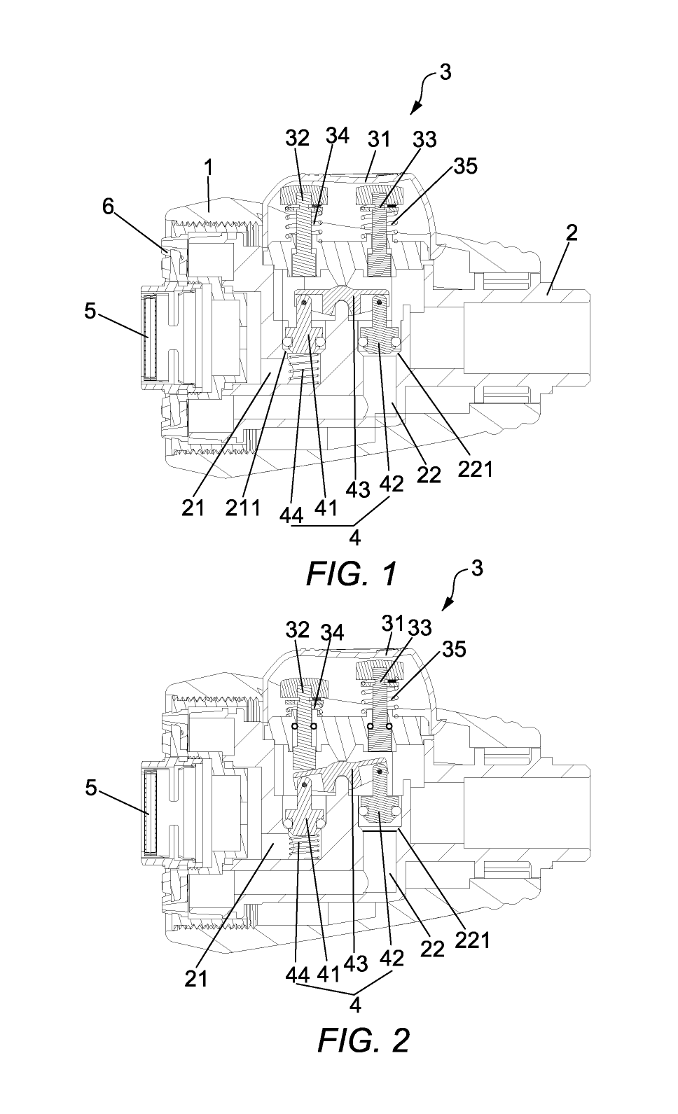

Referring to FIG. 1, a kitchen water faucet of the present invention includes a water faucet body 1, a mandrel 2, a pushbutton mechanism 3, a valve core assembly 4, a bubbler 5, and a face covering 6.

Wherein, the water faucet body 1 is formed by a sleeve, on a sidewall of which an opening hole is defined for receiving the pushbutton mechanism.

Further, the mandrel 2 provided with a rear portion thereof connecting to an outlet pipe and a middle portion thereof forming two intake pipes 21, 22 in a vertical direction, which are respectively communicated with a water inlet of the bubbler 5 and a shower water inlet of the face covering 6.

The pushbutton mechanism 3 includes a pushbutton sleeve 31 and two buttons 32, 33 respectively aiming at the two intake pipes 21, 22. Moreover, the two buttons 32, 33 connect with respective button springs 34, 35 and actively locate between the pushbutton sleeve 31 and a sidewall of the mandrel 2.

A valve core assembly 4 includes two valves 41, 42, a pressure plate 43, and a return spring 44. The two valves 41, 42 sleeved by a sealing unit respectively extend into the two intake pipes 21, 22 of the mandrel 2, and lower portions of which are formed into a converse trapezoid contour for fitting with necks 211, 221 of the intake pipes 21, 22. The return spring 44 is arranged below the valve 41 that is set in the intake pipe for bubble water. Additionally, the middle of the pressure plate 43 pivots to an upside of a partition located between the two intake pipes 21, 22, and two ends of the pressure plate 43 provided with two ends thereof pivotally connect with upsides of the two valves 41, 42, respectively.

The face covering 6 and the bubbler 5 are respectively installed at a front portion of the mandrel 2.

Still referring to FIG. 1, the mandrel 2 is fixed inside the water faucet body 1, and the pushbutton mechanism 3 is installed within the opening hole on the sidewall of the water faucet body 1.

Referring to FIG. 4, when the water faucet is turned off, the pushbutton mechanism 3 is formed as a free state, in which the valve 41 of the valve core assembly 4 is boosted upward through the force of the returning spring 44. That being said the intake pipe 21 of bubble water is opened. Further, since the pressure plate 43 provided with one end thereof boosted by the valve 41, the other end thereof serves to press the valve 42 downward to place the intake pipe 22 serving as an intake pipe of shower water into a closed state. As such, the bubble water would be assured of an initial output at a first time of using.

Referring to FIG. 2, after outputting the water, the button 32 of the pushbutton mechanism 3 is pressed for forwarding the valve 41 downward and hence blocking the intake pipe 21, so as to close the inlet of the bubble water. Further, releasing the pushbutton mechanism 3 while the water pressure is larger than the elasticity of the returning spring 44 would assist in returning the button 32 back through the button spring 34, by which the valve 42 would be concurrently moved upward for opening the shower water intake pipe 22, hence permitting the output of the shower water from the shower water intake inlet.

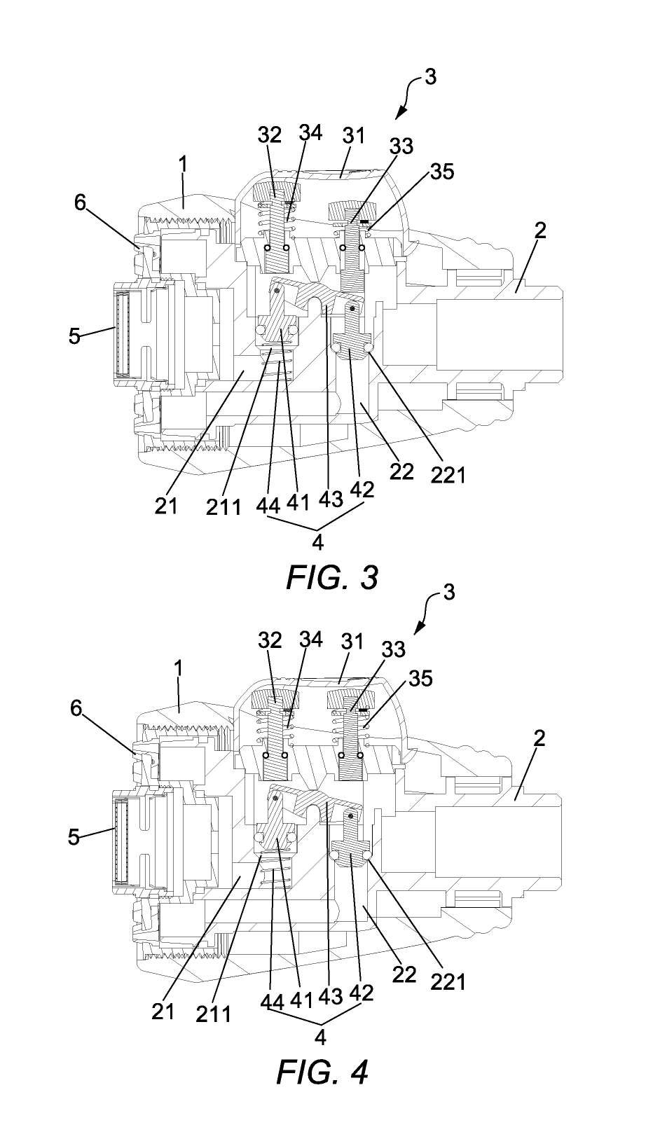

Referring to FIG. 3, throughout the operation for switching to the flush of bubble water, the button 33 of the pushbutton mechanism 3 is actuated for pressing the valve 42 and blocking the intake pipe 22, so as to close the inlet of the shower water. As such, releasing the pushbutton mechanism 3 would assist in returning the button 33 back through the button spring 35, by which the valve 41 would be concurrently moved upward for opening the bubble water intake pipe 21, hence permitting the output of the bubble water from the bubble water intake inlet.

I claim:

1. A switching unit for pushbutton of kitchen water faucet cooperating with a water faucet body, a mandrel, a pushbutton mechanism, a bubbler and a face covering; characterized in that two intake pipes being formed vertically in a middle of said mandrel for respectively communicating with a water inlet of said bubbler and a shower water inlet of said face covering; said pushbutton mechanism being disposed on a sidewall of said water faucet body, which includes two buttons with a returning capability aiming at said two intake pipes, respectively; a valve core assembly including two valves, a pressure plate, and a return spring; said two valves respectively extending into said two intake pipes of said mandrel; said return spring being arranged below said valve that is within said intake pipe serving to guide bubble water; said pressure plate with a middle portion thereof being pivotally connected to an upside of a partition located between said two intake pipes, and two ends of said pressure plate with two ends thereof pivotally connect with upsides of said two valves, respectively.

2. The switching unit for pushbutton of kitchen water faucet as claimed in claim 1, wherein said pushbutton mechanism includes a pushbutton sleeve, and said two buttons connect with button springs and actively locate between said pushbutton sleeve and a sidewall of said mandrel.

3. The switching unit for pushbutton of kitchen water faucet as claimed in claim 1, wherein, said two valves sleeved by a sealing unit respectively extend to said two intakes pipes of said mandrel, and lower portions of which are both formed into a converse trapezoid contour for fitting with necks of said intake pipes.
